(19) United States
(12) Patent Application Publication
(10) Pub. No.: US 2018/0082586 A1
(43) Pub. Date: Mar. 22, 2018

(54) METHOD AND SYSTEM FOR REAL-TIME PREDICTION OF CROWDEDNESS IN VEHICLES IN TRANSIT

(71) Applicant: Conduent Business Services, LLC, Dallas, TX (US)

(72) Inventors: Abhishek Sengupta, Kolkata (IN); Kaushik Baruah, Bangalore (IN); Samrat Sankhya, Kondapi-Mandal (IN); Narayanan Unny Edakunni, Bangalore (IN)

(21) Appl. No.: 15/271,249

(22) Filed: Sep. 21, 2016

(51) Int. Cl. G08G 1/127; G01C 21/34

(52) U.S. Cl. CPC G08G 1/127; G01C 21/343

(57) ABSTRACT

The disclosed embodiments illustrate methods of data processing for real-time prediction of crowdedness in vehicles in transit. The method includes receiving a current location of a vehicle, a real-time traffic information along a route of transit, and a current passenger demand at a first subsequent station and a second subsequent station. The method includes predicting a dwell time for the vehicle corresponding to the first subsequent station. The method includes predicting an arrival time instant of the vehicle at the second subsequent station based on a predicted first travel time of the vehicle, a predicted second travel time of the vehicle, and the predicted dwell time. The method includes predicting a passenger occupancy of the vehicle at the predicted arrival time instant at the second subsequent station based on at least a first passenger demand, a second passenger demand associated with the second subsequent station, and a passenger alighting pattern.

### TECHNICAL FIELD

The presently disclosed embodiments are related, in general, to data processing. More particularly, the presently disclosed embodiments are related to method and system for data processing for real-time prediction of crowdedness in vehicles in transit.

### BACKGROUND

Recent advancements in the field of transportation services have led to the emergence of various types of scheduling techniques for vehicles in a transit network. The types of such scheduling techniques may be determined by transport agencies for transit operations of the vehicles in the transit network. One such scheduling techniques is dynamic scheduling, which is implemented to address the dynamic variations of the transit network. The dynamic scheduling, unlike static scheduling that is primarily based on previously observed passenger demand statistics, is based on real-time vehicle status or predicted vehicle status, such as travel time of a vehicle between two or more stations.

However, in certain scenarios, dynamic scheduling information associated with passenger demand for the vehicles is mostly overlooked in dynamic scheduling techniques. This may lead to the overcrowding of passengers in the vehicles during peak rush hours. Further, various other transit parameters, such a dwell time and arrival time, associated with the vehicles may be affected. Not only does this deteriorate the travel experience for the passengers, but also leads to a loss in revenue for the transport agencies. Therefore, an adaptive and robust technique is required for the real-time prediction of various transit parameters, such as travel time, arrival time instants, crowdedness, and/or the like.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

According to embodiments illustrated herein, there is provided a method data processing by a computing device for real-time prediction of crowdedness in vehicles in transit. The method includes receiving, by one or more transceivers in the computing device, a current location of a vehicle from one or more positional sensors installed in the vehicle, a real-time traffic information along a route of transit, and a current passenger demand for the vehicle at a first subsequent station and a second subsequent station along the route of transit. The method further includes predicting, by one or more processors in the computing device, a dwell time for the vehicle corresponding to the first subsequent station based on a first passenger demand for the vehicle at the first subsequent station at an arrival time instant of the vehicle at the first subsequent station. The method further includes predicting, by the one or more processors, an arrival time instant of the vehicle at the second subsequent station based on a predicted first travel time of the vehicle between the current location and the first subsequent station, a predicted second travel time of the vehicle between the first subsequent station and the second subsequent station, and the predicted dwell time. The method further includes predicting, by the one or more processors, a passenger occupancy of the vehicle at the predicted arrival time instant at the second subsequent station based on at least the first passenger demand, a second passenger demand associated with the second subsequent station, and a passenger alighting pattern at the first subsequent station and the second subsequent station. The method further includes rendering, by the one or more processors, the predicted passenger occupancy of the vehicle at user-interfaces of a plurality of mobile computing devices associated with a vehicle service provider and/or a plurality of passengers.

According to embodiments illustrated herein, there is provided a system for data processing by a computing device for real-time prediction of crowdedness in vehicles in transit. The system includes one or more processors configured to receive a current location of a vehicle from one or more positional sensors installed in the vehicle, a real-time traffic information along a route of transit, and a current passenger demand for the vehicle at a first subsequent station and a second subsequent station along the route of transit. The system includes one or more processors further configured to predict a dwell time for the vehicle corresponding to the first subsequent station based on a first passenger demand for the vehicle at the first subsequent station at an arrival time instant of the vehicle at the first subsequent station. The system includes one or more processors further configured to predict an arrival time instant of the vehicle at the second subsequent station based on a predicted first travel time of the vehicle between the current location and the first subsequent station, a predicted second travel time of the vehicle between the first subsequent station and the second subsequent station, and the predicted dwell time. The system includes one or more processors further configured to predict a passenger occupancy of the vehicle at the predicted arrival time instant at the second subsequent station based on at least the first passenger demand, a second passenger demand associated with the second subsequent station, and a passenger alighting pattern at the first subsequent station and the second subsequent station. The predicted passenger occupancy of the vehicle is rendered at user-interfaces of a plurality of mobile computing devices associated with a vehicle service provider and/or a plurality of passengers.

According to embodiments illustrated herein, there is provided a computer program product for use with a computing device. The computer program product comprises a non-transitory computer readable medium storing a computer program code for data processing for real-time prediction of crowdedness in vehicles in transit. The computer program code is executable by one or more processors to receive a current location of a vehicle from one or more positional sensors installed in the vehicle, a real-time traffic information along a route of transit, and a current passenger demand for the vehicle at a first subsequent station and a second subsequent station along the route of transit. The computer program code is further executable by one or more processors to predict a dwell time for the vehicle corresponding to the first subsequent station based on a first passenger demand for the vehicle at the first subsequent station at an arrival time instant of the vehicle at the first subsequent station. The computer program code is further executable by one or more processors to predict an arrival time instant of the vehicle at the second subsequent station based on a predicted first travel time of the vehicle between the current location and the first subsequent station, a predicted second travel time of the vehicle between the first subsequent station and the second subsequent station, and the predicted dwell time. The computer program code is further executable by one or more processors to predict a passenger occupancy of the vehicle at the predicted arrival time instant at the second subsequent station based on at least the first passenger demand, a second passenger demand associated with the second subsequent station, and a passenger alighting pattern at the first subsequent station and the second subsequent station. Further, the predicted passenger occupancy of the vehicle is rendered at user-interfaces of a plurality of mobile computing devices associated with a vehicle service provider and/or a plurality of passengers.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Furthermore, the elements may not be drawn to scale.

Various embodiments will hereinafter be described in accordance with the appended drawings, which are provided to illustrate the scope and not to limit it in any manner, wherein like designations denote similar elements, and in which:

FIG. 1 is a block diagram that illustrates a system environment, in which various embodiments can be implemented, in accordance with at least one embodiment;

FIG. 2 is a block diagram that illustrates an application server, in accordance with at least one embodiment;

FIGS. 3A and 3B, collectively, depict a flowchart that illustrates a method for real-time prediction of crowdedness in vehicles in transit, in accordance with at least one embodiment;

FIG. 4 is a block diagram that illustrates an exemplary scenario for real-time prediction of crowdedness in vehicles in transit, in accordance with at least one embodiment;

FIG. 5 is a block diagram that illustrates an exemplary scenario to render a first user-interface on a mobile computing device associated with a passenger for displaying a real-time prediction of crowdedness in a vehicle at a station, in accordance with at least one embodiment; and

FIG. 6 is a block diagram that illustrates an exemplary scenario to render a second user-interface on a mobile computing device associated with a service provider of a vehicle for displaying a real-time prediction of crowdedness in the vehicle at a plurality of stations along a route of transit, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on, indicate that the embodiment(s) or example(s) may include a particular feature, structure, characteristic, property, element, or limitation, but that not every embodiment or example necessarily includes that particular feature, structure, characteristic, property, element, or limitation. Furthermore, repeated use of the phrase “in an embodiment” does not necessarily refer to the same embodiment.

Definitions: The following terms shall have, for the purposes of this application, the meanings set forth below.

A “mobile computing device” refers to a computer, a device (that includes one or more processors/microcontrollers and/or any other electronic components), or a system (that performs one or more operations according to one or more programming instructions/codes) associated with a user, such as a passenger or a service provider of a vehicle. In an embodiment, the mobile computing device may be utilized by the user to transmit a request for inquiring about passenger occupancy in a vehicle at specified station(s). Examples of the mobile computing device may include, but are not limited to, a laptop, a personal digital assistant (PDA), a mobile device, a smartphone, and a tablet computer (e.g., iPad® and Samsung Galaxy Tab®).

A “plurality of passengers” refers to a plurality of commuters, who may avail a transport facility, such as a vehicle, to commute between two stations along a route. In an embodiment, a passenger of the plurality of passengers may swipe an access card to sign-in, while entering a source station and may again swipe the access card to sign-out while leaving a destination station. In an embodiment, the passenger may pay some incentives in exchange for the transport facility. Hereinafter, “user,” “commuter,” “traveler,” “rider,” “requestor,” or “passenger” may be interchangeably used.

A “vehicle” refers to a means of transportation that may transport one or more passengers and/or cargos between two or more locations along a route. In an embodiment, one or more passengers may share the vehicle during the transit along the route. In an embodiment, the vehicle may be installed with a vehicle-computing device. In an embodiment, the vehicle may correspond to a bus, a truck, a car, a ship, an airplane, and/or the like.

A “vehicle-computing device” refers to a computer, a device (that includes one or more processors/microcontrollers and/or any other electronic components), or a system (that performs one or more operations according to one or more programming instructions/codes) installed in a vehicle. In an embodiment, the vehicle-computing device may include one or more positional sensors, such as inbuilt global positioning system (GPS) sensors. Examples of the vehicle-computing device may include, but are not limited to, a laptop, a personal digital assistant (PDA), a mobile device, a smartphone, and a tablet computer (e.g., iPad® and Samsung Galaxy Tab®).

A “route” refers to a path that may be traversed by a vehicle to pick up or drop one or more passengers of a plurality of passengers. In an embodiment, the route may include a plurality of stations corresponding to a plurality of locations. The plurality of stations may occur in a predetermined sequence along the route. In an embodiment, the route may comprise at least two stations having at least one source station and one destination station. For example, a city bus travels from Harlem to East Village in New York. Thus, the path from Harlem to East Village may correspond to a route with Harlem being a source station and East Village being a destination station. In an embodiment, while travelling along the route, the vehicle may have crossed one or more stations among the plurality of stations. Further, the vehicle may cross the remaining stations along the course of the route. In an embodiment, the remaining stations that are yet to be traversed by the vehicle are referred to as subsequent stations. The first station among the subsequent stations is referred as first subsequent station, the second station among the subsequent stations is referred as second subsequent station, and so on.

“Real-time traffic information” refers to real-time traffic congestion information on one or more routes. In an embodiment, the real-time traffic information on a route may be captured by one or more supervision cameras installed at one or more locations along the route. In another embodiment, one or more traffic tracking agencies may keep a track of the real-time traffic information on the one or more routes based on information received from the one or more supervision cameras or one or more crowd-sourcing platforms.

“Current location” of a vehicle refers to a real-time location of the vehicle while the vehicle is in transit along a route. In an embodiment, the current location of the vehicle may correspond to a station among a plurality of stations along the route of transit. For example, the vehicle may be waiting at a station to pick up passengers, who want to travel from the station to another station. In such a case, the station may correspond to the current location. In another embodiment, the current location may correspond to an intermediate location traversed by the vehicle, while the vehicle is moving along the route to reach a station.

“Current passenger demand” for a vehicle at a station refers to a real-time count of passengers, who are waiting to board the vehicle. In an embodiment, the passengers constituting the current passenger demand may have swiped corresponding access cards to sign-in while entering the station. In an embodiment, the current passenger demand for the vehicle may be updated after a pre-defined period. For example, a ticketing record of passengers swiping their access cards may be updated after every “2 minutes.” In this scenario, the ticketing record of passengers at any time instant may represent the current passenger demand at the corresponding time instant.

“First passenger demand” for a vehicle at a first subsequent station refers to a count of passengers, who are predicted to board the vehicle when the vehicle arrives at the first subsequent station at a predicted arrival time instant. In an embodiment, the first passenger demand may be predicted based on a current passenger demand at the first subsequent station and historical data. In an embodiment, the first passenger demand may be predicted by utilizing one or more filtering techniques, such as Kalman filtering technique or Hidden Markov Model (HMM) filtering technique, known in the art.

“Second passenger demand” for a vehicle at a second subsequent station refers to a count of passengers, who are predicted to board the vehicle when the vehicle arrives at the second subsequent station at a predicted arrival time instant. In an embodiment, the second passenger demand may be predicted based on a current passenger demand at the second subsequent station and historical data. In an embodiment, the second passenger demand may be predicted by utilizing one or more filtering techniques, such as the Kalman filtering technique or HMM filtering technique, known in the art.

“Travel time” refers to time taken by a vehicle to travel from one location to another location along a route of transit. In an embodiment, the travel time taken by the vehicle to travel between two stations along the route may be predicted based on historically observed time taken by the vehicle to travel between the two stations and real-time traffic information along the route. In an embodiment, the predicted travel time of the vehicle between a current location of the vehicle and a first subsequent station may correspond to a first travel time. In an embodiment, the predicted travel time of the vehicle between the first subsequent station and a second subsequent station may correspond to a second travel time.

An “arrival time instant” of a vehicle at a station refers to a time instant at which the vehicle arrives at the station. In an embodiment, the arrival time instant of the vehicle at a station may be predicted based on a travel time between a current location of the vehicle and the station. In an embodiment, the arrival time instant of the vehicle at the station may be further predicted based on a dwell time associated with the current location, when the current location corresponds to another station. For example, a vehicle may be moving towards a first subsequent station from a current location (i.e., an intermediate location) along a route. In this scenario, the arrival time instant of the vehicle at the first subsequent station may be predicted based on a predicted travel time between the current location and the first subsequent station. The vehicle may be further scheduled to travel to a second subsequent station, which may be a next station after the first subsequent station. In this scenario, the arrival time instant of the vehicle at the second subsequent station may be predicted based on the predicted travel time between the current location and the first subsequent station, a predicted travel time between the first subsequent station and the second subsequent station, and a dwell time associated with the first subsequent station.

A “dwell time” corresponding to a station refers to a time interval elapsed between an arrival time instant of a vehicle at the station and a departure time instant of the same vehicle from the station. For example, a bus may arrive at a station at “11:10:00 a.m.” and may depart from the station at “11:10:21 a.m.” In such a case, for the station, the dwell time may be “21 seconds.” In an embodiment, the dwell time of a station may be associated with passenger demand for the vehicle at the station. The dwell time may increase, when passenger demand for the vehicle increases, as the time taken by the passengers to board the vehicle accounts for the dwell time.

“Passenger occupancy” refers to a count of passengers in a vehicle at a station, who want to travel to any subsequent station. In an embodiment, the passenger occupancy of a vehicle may be determined based on a count of passengers boarding (i.e., passenger demand for the vehicle at the station) the vehicle at the station, a count of passengers alighting from the vehicle at the station, and a previous count of passengers seated in the vehicle, when the vehicle arrived at the station. For example, there may be “20 passengers” seated in a vehicle “V,” when the vehicle “V” arrived at a station “A.” Further, of those “20 passengers,” “5 passengers” alight from the vehicle “V” and “10 passengers” board the vehicle “V.” In such a case, the passenger occupancy of the vehicle “V” at the station “A” is “25 passengers” (i.e., 20+10−5=25). In an embodiment, the passenger occupancy of the vehicle may be predicted, if all the parameters, such as the count of passengers boarding the vehicle, the count of passengers alighting the vehicle, and the previous count of passengers seated in the vehicle, are known or predicted. Hereinafter, the terms “passenger occupancy” or “crowdedness” are used interchangeably, without deviating from the scope of the disclosure.

An “alighting pattern” of passengers corresponding to a station represents a relationship between a count of passengers alighting from a vehicle at the station and a count of passengers who boarded the vehicle at one or more prior stations. In an embodiment, the alighting pattern may be determined from a travel history of a plurality of passengers. For example, the alighting pattern may indicate a count of passengers who will get down from the vehicle at a station “B” as a function of a count of passengers who boarded the vehicle at a station “A,” such that the station “A” is prior to the station “B.”

“Historical data” refers to data collected based on previous records. In an embodiment, the historical data may comprise an observed travel time of a vehicle among a plurality of stations along a route of transit, a count of passengers boarding the vehicle at each of the plurality of stations, a count of passengers alighting the vehicle at each of the plurality of stations, and an observed passenger demand for the vehicle at each of the plurality of stations. In an embodiment, the historical data may further comprise details pertaining to a travel history of each passenger among a plurality of passengers. In an embodiment, the historical data may further comprise information pertaining to an observed traffic along the route in the past and an observed dwell time at each of the plurality of stations.

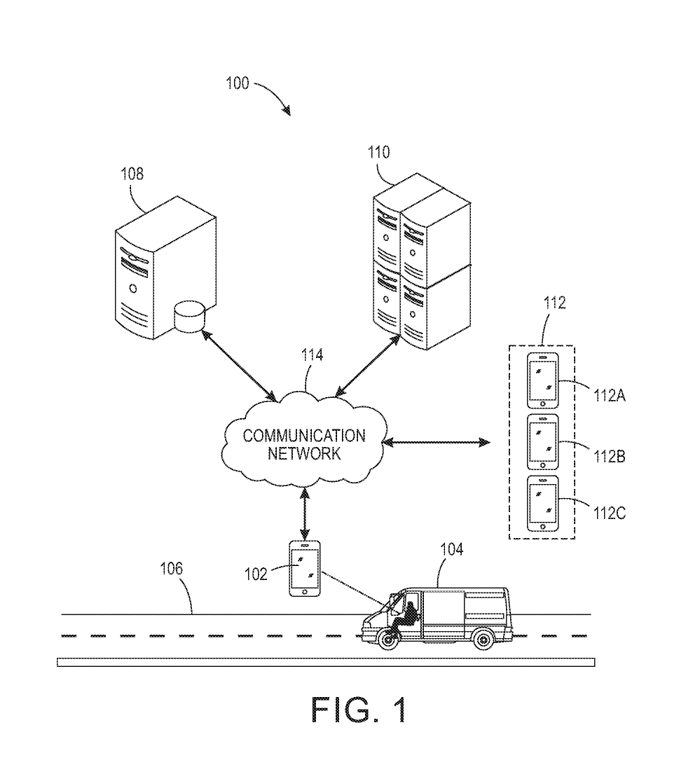

FIG. 1 is a block diagram of a system environment in which various embodiments may be implemented. With reference to FIG. 1, there is shown a system environment 100 that includes a vehicle-computing device 102 associated with a vehicle 104. Further, the vehicle 104 may be transiting along a route 106. The system environment 100 further includes a database server 108, an application server 110, a plurality of mobile computing devices 112, such as mobile computing devices 112A to 112C, and a communication network 114. Various devices in the system environment 100 may be interconnected over the communication network 114. FIG. 1 shows, for simplicity, one vehicle-computing device, such as the vehicle-computing device 102, associated with one vehicle, such as the vehicle 102A, one database server, such as the database server 108, one application server, such as the application server 110, and three mobile computing devices, such as the mobile computing devices 112A to 112C. However, it will be apparent to a person having ordinary skill in the art that the disclosed embodiments may also be implemented using multiple vehicle-computing devices, multiple vehicles, multiple database servers, multiple application servers, and multiple mobile computing devices, without departing from the scope of the disclosure.

The vehicle-computing device 102 may refer to a computing device, installed in the vehicle 104, which may be communicatively coupled to the communication network 114. Further, the vehicle-computing device 102 may include one or more processors and one or more memory units. The one or more memory units may include a computer readable code that may be executable by the one or more processors to perform one or more operations as specified by a service provider of the vehicle 104 and/or a driver of the vehicle 104. In an embodiment, the vehicle-computing device 102 may comprise a navigation device with inbuilt one or more positional sensors, such as GPS sensors. In an embodiment, the one or more positional sensors in the vehicle-computing device 102 may be configured to detect a current location of the vehicle 104, while the vehicle 104 is in transit along the route 106. Further, the vehicle-computing device 102 may be configured to transmit information pertaining to the current location of the vehicle 104 to the application server 110. In an embodiment, the vehicle-computing device 102 may be configured to present a navigational map to guide the driver of the vehicle 104 along the route 106.

The vehicle-computing device 102 may correspond to a variety of computing devices, such as, but not limited to, a laptop, a PDA, a tablet computer, a smartphone, and a phablet.

The database server 108 may refer to a computing device that may be communicatively coupled to the communication network 114. In an embodiment, the database server 108 may be configured to perform one or more database operations. The one or more database operations may include one or more of, but are not limited to, receiving, storing, processing, and transmitting one or more queries, data, or content. The one or more queries, data, or content may be received/transmitted from/to various components of the system environment 100. In an embodiment, the database server 108 may be configured to store historical data. In an embodiment, the historical data may comprise information pertaining to an observed travel time of the vehicle 104 among a plurality of stations along the route 106, a count of passengers boarding the vehicle 104 at each of the plurality of stations, a count of passengers alighting the vehicle 104 at each of the plurality of stations, and an observed passenger demand for the vehicle 104 at each of the plurality of stations. In an embodiment, the historical data may further comprise past traffic information along the route 106 and an observed dwell time at each of the plurality of stations.

In an embodiment, the database server 108 may further comprise a travel history of each passenger among a plurality of passengers. The travel history of the passenger may comprise a log of time instants at which the passenger may have travelled in the vehicle 104 in past. The log of time instants may be indicative of at least a sign-in and a sign-out of the passenger at the plurality of stations along the route 106. In an embodiment, the passenger may use a corresponding access card to sign-in to board the vehicle 104 at a station among the plurality of stations. Further, the same passenger may use the corresponding access card to sign-out after alighting the vehicle 104 at any other station. In an embodiment, the log of time instants may be extracted from databases of one or more electronic ticketing systems or other transportation agencies. In an embodiment, the database server 108 may be configured to receive one or more queries from the application server 110 for the retrieval of historical data and the travel history of the plurality of passengers.

For querying the database server 108, one or more querying languages, such as, but not limited to, SQL®, QUEL®, and DMX®, may be utilized. In an embodiment, the database server 108 may connect to the application server 110, using one or more protocols, such as, but not limited to, the ODBC® protocol and the JDBC® protocol. In an embodiment, the database server 108 may be realized through various technologies such as, but not limited to, Microsoft® SQL Server, Oracle®, IBM DB2®, Microsoft Access®, PostgreSQL®, MySQL® and SQLite®.

The application server 110 may refer to an electronic device, a computing device, or a software framework hosting an application or a software service that may be communicatively coupled to the communication network 114. In an embodiment, the application server 110 may be implemented to execute programs, routines, scripts, and/or the like, stored in one or more memory units for supporting the hosted application or the software service. In an embodiment, the hosted application or the software service may be configured to perform one or more predetermined operations for real-time prediction of crowdedness in one or more vehicles in transit.

In an embodiment, the application server 110 may be configured to receive a request from a mobile computing device, such as one of the mobile computing devices 112A to 112C, associated with a passenger from a plurality of passengers or a service provider of the vehicle 104. Thereafter, based on the request the application server 110 may retrieve information pertaining to a current location of the vehicle 104, a real-time traffic information along the route 106 of transit of the vehicle 104, and a current passenger demand for the vehicle 104 at one or more subsequent stations, such as a first subsequent station and a second subsequent station along the route 106 of transit. In an embodiment, the plurality of stations along the route 106 may comprise the one or more subsequent stations. The application server 110 may query the vehicle-computing device 102 and one or more data sources, such as the database server 108, to retrieve the information.

Thereafter, in an embodiment, the application server 110 may be configured to predict a first travel time of the vehicle 104 between the current location and the first subsequent station, and a second travel time of the vehicle 104 between the first subsequent station and the second subsequent station. In an embodiment, the application server 110 may be configured to predict the first travel time and the second travel time based on the historical data, the current location of the vehicle 104, and the real-time traffic information. In an embodiment, the application server 110 may be configured to utilize one or more filtering techniques, such as Kalman filtering technique or Hidden Markov Model (HMM) filtering technique, known in the art for the prediction of the first travel time and the second travel time.

In an embodiment, the application server 110 may be further configured to predict an arrival time instant of the vehicle 104 at the first subsequent station based on the predicted first travel time. In an embodiment, the application server 110 may be configured to predict a first passenger demand for the vehicle 104 at the arrival time instant at the first subsequent station. In an embodiment, the application server 110 may be configured to predict the first passenger demand based on the historical data and the current passenger demand at the first subsequent station.

Thereafter, the application server 110 may be configured to predict a dwell time for the vehicle 104 corresponding to the first subsequent station. In an embodiment, the application server 110 may be configured to predict the dwell time corresponding to the first subsequent station based on the predicted first passenger demand for the vehicle 104 at the first subsequent station at the arrival time instant of the vehicle 104 at the first subsequent station.

Thereafter, the application server 110 may be configured to predict an arrival time instant of the vehicle 104 at the second subsequent station. In an embodiment, the application server 110 may be configured to predict the arrival time instant of the vehicle 104 at the second subsequent station based on the predicted first travel time, the predicted second travel time, and the predicted dwell time. In an embodiment, the application server 110 may be further configured to predict a second passenger demand for the vehicle 104 at the predicted arrival time instant at the second subsequent station. In an embodiment, the application server 110 may be configured to predict the second passenger demand, based on the historical data and the current passenger demand at the second subsequent station.

In an embodiment, the application server 110 may be configured to determine a passenger alighting pattern at each of the plurality of stations along the route 106 of transit. In an embodiment, the application server 110 may be configured to determine the passenger alighting pattern based on the historical data. Thereafter, in an embodiment, the application server 110 may be configured to predict passenger occupancy of the vehicle 104 at the predicted arrival time instant at the second subsequent station. In an embodiment, the application server 110 may be configured to predict the passenger occupancy of the vehicle 104 at the predicted arrival time instant at the second subsequent station, based on at least the first passenger demand, the second passenger demand, and the passenger alighting pattern at the first subsequent station and the second subsequent station. In an embodiment, the application server 110 may be further configured to predict the passenger occupancy of the vehicle 104 at the predicted arrival time instant at the first subsequent station.

After predicting the passenger occupancy, the application server 110 may be configured to render the predicted passenger occupancy of the vehicle 104 on user-interfaces of the plurality of mobile computing devices 112 associated with the vehicle service provider and/or the plurality of passengers.

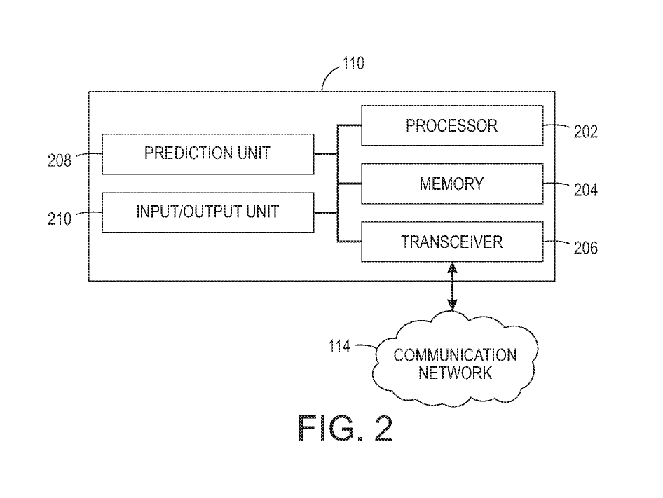

The application server 110 may be realized through various types of application servers, such as, but not limited to, a Java application server, a .NET framework application server, a Base4 application server, a PHP framework application server, or any other application server framework. An embodiment of the structure of the application server 110 has been discussed later in FIG. 2.

Each of the plurality of mobile computing devices 112 may refer to a computing device that may be communicatively coupled to the communication network 114. In an embodiment, a mobile computing device, such as the mobile computing devices 112A and 112C, may be associated with a passenger of the plurality of passengers. In an embodiment, a mobile computing device, such as the mobile computing devices 1128, may be associated with the service provider of the vehicle 104. Each of the plurality of mobile computing devices 112, such as the mobile computing devices 112A to 112C, may comprise one or more processors and one or more memory units. The one or more memory units may include computer readable codes and instructions that may be executable by the one or more processors to perform one or more predetermined operations specified by the corresponding passenger of the plurality of passengers and/or the service provider of the vehicle 104. In an embodiment, a passenger or the service provider may utilize the corresponding mobile computing device, such as one of the mobile computing devices 112A to 112C, to provide the request to inquire about the passenger occupancy of the vehicle 104 at any station, such as the first subsequent station and/or the second subsequent station, of interest.

Each of the plurality of mobile computing devices 112 may correspond to a variety of computing devices, such as, but not limited to, a laptop, a PDA, a tablet computer, a smartphone, and a phablet.

A person having ordinary skill in the art will appreciate that the scope of the disclosure is not limited to realizing the application server 110 and the plurality of mobile computing devices 112, as separate entities. In an embodiment, the application server 110 may be realized as an application program installed on and/or running on each of the plurality of mobile computing devices 112, without deviating from the scope of the disclosure. Further, in an embodiment, the functionalities of the database server 108 can be integrated into the functionalities of the application server 110, without departing from the scope of the disclosure.

The communication network 114 may correspond to a medium through which content and messages flow between various devices, such as the vehicle-computing device 102, the database server 108, the application server 110, and the plurality of mobile computing devices 112 of the system environment 100. Examples of the communication network 114 may include, but are not limited to, the Internet, a cloud network, a Wireless Fidelity (Wi-Fi) network, a Wireless Local Area Network (WLAN), a Local Area Network (LAN), a wireless personal area network (WPAN), a wireless wide area network (WWAN), a cloud network, a Long Term Evolution (LTE) network, a plain old telephone service (POTS), and/or a Metropolitan Area Network (MAN). Various devices in the system environment 100 can connect to the communication network 114 in accordance with various wired and wireless communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, such as Long Term Evolution (LTE), Light Fidelity (Li-Fi), and/or other cellular communication protocols or Bluetooth (BT) communication protocols.

FIG. 2 is a block diagram that illustrates an application server, in accordance with at least one embodiment. FIG. 2 has been described in conjunction with FIG. 1. With reference to FIG. 2, there is shown a block diagram of the application server 110 that may include a processor 202, a memory 204, a transceiver 206, a prediction unit 208, and an input/output (I/O) unit 210. The processor 202 is communicatively coupled to the memory 204, the transceiver 206, the prediction unit 208, and the I/O unit 210.

The processor 202 includes suitable logic, circuitry, and/or interfaces that are configured to execute one or more instructions stored in the memory 204. The processor 202 may further comprise an arithmetic logic unit (ALU) (not shown) and a control unit (not shown). The ALU may be coupled to the control unit. The ALU may be configured to perform one or more mathematical and logical operations and the control unit may control the operation of the ALU. The processor 202 may execute a set of instructions/programs/codes/scripts stored in the memory 204 to perform one or more operations for the real-time prediction of crowdedness in the one or more vehicles in transit. In an embodiment, the processor 202 may be configured to query the vehicle-computing device 102, the database server 108, and the one or more traffic tracking agencies for retrieving required information, such as the current location of the vehicle 104, the real-time traffic information along the route 106 of transit, and the current passenger demand at the one or more subsequent stations (i.e., the first subsequent station and the second subsequent station) along the route 106. In an embodiment, the processor 202 may be configured to determine the passenger alighting pattern at each of the plurality of stations along the route 106 of transit. The processor 202 may be implemented based on a number of processor technologies known in the art. Examples of the processor 202 may include, but are not limited to, an X86-based processor, a Reduced Instruction Set Computing (RISC) processor, an Application-Specific Integrated Circuit (ASIC) processor, and/or a Complex Instruction Set Computing (CISC) processor.

The memory 204 may be operable to store one or more machine codes, and/or computer programs having at least one code section executable by the processor 202. The memory 204 may store the one or more sets of instructions that are executable by the processor 202, the transceiver 206, the prediction unit 208, and the I/O unit 210. In an embodiment, the memory 204 may include one or more buffers (not shown). The one or more buffers may store the predicted first travel time, the predicted second travel time, the predicted first passenger demand, the predicted second passenger demand, and the predicted dwell time. In an embodiment, the one or more buffers may be configured to store intermediate information, such as the passenger alighting pattern, the arrival time instants of the vehicle at each of the one or more subsequent stations, such as the first subsequent station and the second subsequent station, determined/predicted prior to/during the prediction of the real-time crowdedness of the vehicle 104. In an embodiment, the one or more buffers may further store one or more algorithms/codes/instructions of the one or more filtering techniques, such as Kalman filtering technique or Hidden Markov Model (HMM) filtering technique. Examples of some of the commonly known memory implementations may include, but are not limited to, a random access memory (RAM), a read only memory (ROM), a hard disk drive (HDD), and a secure digital (SD) card. In an embodiment, the memory 204 may include the one or more machine codes, and/or computer programs that are executable by the processor 202 to perform specific operations for the real-time prediction of crowdedness in the one or more vehicles in transit. It will be apparent to a person having ordinary skill in the art that the one or more instructions stored in the memory 204 may enable the hardware of the application server 110 to perform the one or more predetermined operations, without deviating from the scope of the disclosure.

The transceiver 206 transmits/receives messages and data to/from various components, such as the vehicle-computing device 102, the database server 108, and each of the plurality of mobile computing devices 112 of the system environment 100, over the communication network 114. In an embodiment, the transceiver 206 may be communicatively coupled to the communication network 114. In an embodiment, the transceiver 206 may be configured to receive information, such as the current location of the vehicle 104, the real-time traffic information along the route 106 of transit, and the current passenger demand for the vehicle 104 at the first subsequent station and the second subsequent station along the route 106 of transit, from one or more sources, such as the vehicle-computing device 102, the database server 108, and the one or more traffic tracking agencies, over the communication network 114. The transceiver 206 may implement one or more known technologies to support wired or wireless communication with the communication network 114. In an embodiment, the transceiver 206 may include circuitry, such as, but not limited to, an antenna, a radio frequency (RF) transceiver, one or more amplifiers, a tuner, one or more oscillators, a digital signal processor, a Universal Serial Bus (USB) device, a coder-decoder (CODEC) chipset, a subscriber identity module (SIM) card, and/or a local buffer. The transceiver 206 may communicate via wireless communication with networks, such as the Internet, an Intranet and/or a wireless network, such as a cellular telephone network, a WLAN and/or a MAN. The wireless communication may use any of a plurality of communication standards, protocols, and technologies, such as: Global System for Mobile Communications (GSM), Enhanced Data GSM Environment (EDGE), wideband code division multiple access (W-CDMA), code division multiple access (CDMA), time division multiple access (TDMA), Bluetooth, Light Fidelity (Li-Fi), Wireless Fidelity (Wi-Fi) (e.g., IEEE 802.11a, IEEE 802.11b, IEEE 802.11g and/or IEEE 802.11n), voice over Internet Protocol (VoIP), Wi-MAX, and a protocol for email, instant messaging, and/or Short Message Service (SMS).

The prediction unit 208 includes suitable logic, circuitry, and/or interfaces that are configured to execute one or more instructions stored in the memory 204. In an embodiment, the prediction unit 208 may be configured to predict data, such as the first travel time, the second travel time, the first passenger demand, and the second passenger demand, required to predict the passenger occupancy of the vehicle 104 at the one or more subsequent stations. In an embodiment, the prediction unit 208 may be further configured to predict the arrival time instants of the vehicle 104 at the one or more subsequent stations, such as the first subsequent station and the second subsequent station, and the dwell time corresponding to each of the plurality of stations. Examples of the prediction unit 208 may include, but are not limited to, an X86-based processor, a RISC processor, an ASIC processor, a CISC processor, and/or other processor.

A person having ordinary skill in the art will appreciate that the scope of the disclosure is not limited to realizing the prediction unit 208 and the processor 202 as separate entities. In an embodiment, the functionalities of the prediction unit 208 may be implemented within the processor 202, without departing from the spirit of the disclosure. Further, a person skilled in the art will understand that the scope of the disclosure is not limited to realizing the prediction unit 208 as a hardware component. In an embodiment, the prediction unit 208 may be implemented as a software module included in computer program code (stored in the memory 204), which may be executable by the processor 202 to perform the functionalities of the prediction unit 208.

The I/O unit 210 may comprise suitable logic, circuitry, interfaces, and/or code that may be configured to provide an output to the first user. The I/O unit 210 comprises various input and output devices that are configured to communicate with the processor 202. Examples of the input devices may include, but are not limited to, a keyboard, a mouse, a joystick, a touch screen, a microphone, a camera, and/or a docking station. Examples of the output devices may include, but are not limited to, a display screen and/or a speaker.

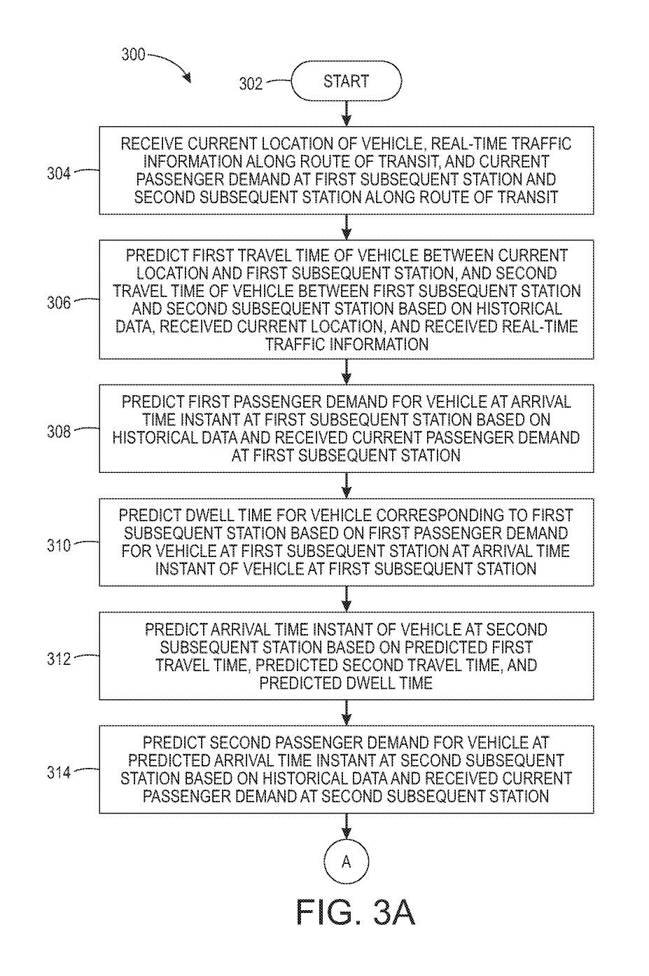

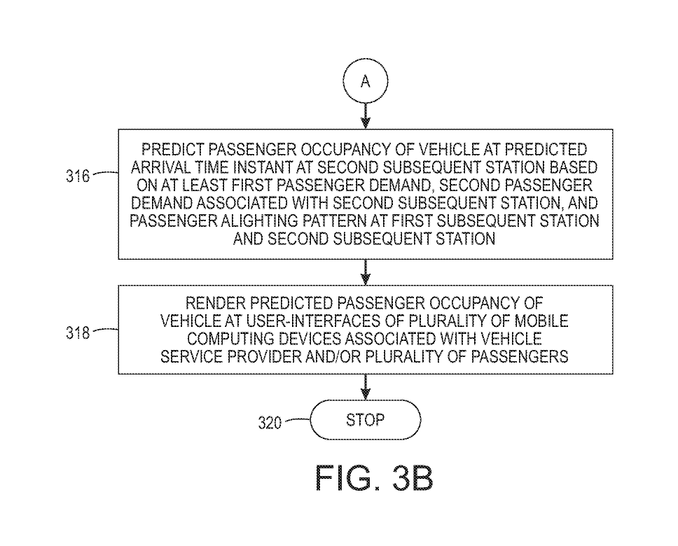

An embodiment of the working of the application server 110 for the real-time prediction of crowdedness in the one or more vehicles in transit has been explained later in FIGS. 3A and 3B.

FIGS. 3A and 3B, collectively, depict a flowchart that illustrates a method for real-time prediction of crowdedness in vehicles, in accordance with at least one embodiment. FIGS. 3A and 3B are described in conjunction with FIG. 1 and FIG. 2. With reference to FIGS. 3A and 3B, there is shown a flowchart 300 that illustrates a method for the real-time prediction of crowdedness in the one or more vehicles. A person with ordinary skills in the art will understand that for brevity, the route 106 comprises only two stations (i.e., the first subsequent station and the second subsequent station) subsequent to the current location of the vehicle 104. Notwithstanding, the disclosure may not be so limited, and the route 106 may include more than two subsequent stations, without deviating from the scope of the disclosure. Further, the first subsequent station and the second subsequent station may collectively be referred to as the one or more subsequent stations. The method starts at step 302 and proceeds to step 304.

At step 304, the current location of the vehicle, the real-time traffic information along the route of transit, and the current passenger demand for the vehicle at the first subsequent station and the second subsequent station along the route of transit are received. In an embodiment, the processor 202, in conjunction with the transceiver 206, may be configured to receive the current location of the vehicle 104, the real-time traffic information along the route 106 of transit, and the current passenger demand at the first subsequent station and the second subsequent station along the route 106. In an embodiment, the processor 202 may be configured to query the vehicle-computing device 102, the database server 108, and the one or more traffic tracking agencies to retrieve the current location of the vehicle 104, the current passenger demand at the first subsequent station and the second subsequent station along the route 106, and the real-time traffic information along the route 106 of transit.

In an embodiment, the processor 202 may be configured to query the vehicle-computing device 102, the database server 108, and the one or more traffic tracking agencies, when the request is received from a mobile computing device, such as one of the mobile computing devices 112A to 112C. In an embodiment, the request may be provided by a passenger from the plurality of passengers and/or the service provider of the vehicle 104 to inquire about the passenger occupancy of the vehicle 104 at the one or more subsequent stations. In an exemplary scenario, a passenger may want to board the vehicle 104 from the second subsequent station along the route 106. In such a case, the passenger may utilize his/her mobile computing device, such as the mobile computing device 112A, to provide the request to inquire about the passenger occupancy of the vehicle 104 at the arrival time instant of the vehicle 104 at the second subsequent station. In another exemplary scenario, the service provider of the vehicle 104 may want to plan the schedule of the vehicle 104 along the route 106. In such a case, the service provider may utilize his/her mobile computing device, such as the mobile computing device 112B, to provide the request to inquire about the passenger occupancy of the vehicle 104 at the arrival time instant of the vehicle 104 at each of the one or more subsequent stations along the route 106.

A person having ordinary skill in the art will understand that the abovementioned exemplary scenarios are for illustrative purpose and should not be construed to limit the scope of the disclosure.

Based on the request, the processor 202, in conjunction with the transceiver 206, may be configured to query the vehicle-computing device 102 installed in the vehicle 104 for retrieving the current location of the vehicle 104. Based on the query, the one or more positional sensors, such as the GPS sensors, may be configured to determine geographical coordinates pertaining to the current location of the vehicle 104. Thereafter, the one or more positional sensors may be configured to transmit information, such as the geographical coordinates, pertaining to the current location of the vehicle 104 to the processor 202. For example, the one or more positional sensors may determine that the vehicle 104 was at geographical coordinates (x₁, y₁), when the query from the processor 202 was received. Thus, the geographical coordinates (x₁, y₁) may correspond to the current location of the vehicle 104. In an embodiment, the current location of the vehicle 104 may correspond to a station among the plurality of stations or an intermediate location traversed by the vehicle 104, while the vehicle 104 is moving along the route 106 to reach the first subsequent station.

A person having ordinary skill in the art will understand that the abovementioned example is for illustrative purpose and should not be construed to limit the scope of the disclosure.

Further, based on the request, the processor 202 may be configured to query the one or more traffic tracking agencies known in the art for receiving the real-time traffic information. Thereafter, based on the query the processor 202 may be configured to receive the real-time traffic information along the route 106 of transit.

Further, based on the request, the processor 202 may be configured to query the database server 108 to receive the current passenger demand for the vehicle 104 at the first subsequent station and the second subsequent station along the route 106. In an embodiment, the current passenger demand for the vehicle 104 may comprise details pertaining to a count of passengers, who want to board the vehicle 104 at the first subsequent station and the second subsequent station. For example, “10” passengers may have swiped their access cards to sign-in at the first subsequent station and “8” passengers may have swiped their access cards to sign-in at the second subsequent station. In such a case, the current passenger demand at the first subsequent station is “10 passengers” and the current passenger demand at the second subsequent station is “8 passengers.” The total current passenger demand for the vehicle 104 along the route 106 is “18 passengers.”

A person having ordinary skill in the art will understand that the abovementioned example is for illustrative purpose and should not be construed to limit the scope of the disclosure.

At step 306, the first travel time of the vehicle between the current location and the first subsequent station, and the second travel time of the vehicle between the first subsequent station and the second subsequent station is predicted. The first travel time and the second travel time are predicted based on the historical data, the current location of the vehicle, and the real-time traffic information along the route of transit. In an embodiment, the prediction unit 208, in conjunction with the processor 202, may be configured to predict the first travel time of the vehicle 104 between the current location and the first subsequent station, and the second travel time of the vehicle 104 between the first subsequent station and the second subsequent station. The prediction unit 208 may be configured to predict the first travel time and the second travel time based on the historical data, the current location of the vehicle 104, and the real-time traffic information along the route 106 of transit.

Prior to the prediction of the first travel time and the second travel time, the processor 202 may be configured to query the database server 108 for retrieving the historical data pertaining to the route 106. In an embodiment, the historical data may comprise information pertaining to the observed travel time of the vehicle 104 between the plurality of stations along the route 106, the count of passengers boarding the vehicle 104 at each of the plurality of stations, the count of passengers alighting the vehicle 104 at each of the plurality of stations, and the observed passenger demand for the vehicle 104 at each of the plurality of stations. Further, the historical data may comprise the past traffic information along the route 106 and the observed dwell time at each of the plurality of stations.

Thereafter, the prediction unit 208 may utilize the historical data, the current location of the vehicle 104, and the real-time traffic information to predict the first travel time and the second travel time. In an embodiment, the prediction unit 208 may be configured to train a travel time predictor model by utilizing one or more filtering techniques, such as Kalman filtering technique or Hidden Markov Model (HMM) filtering technique, known in the art. In an embodiment, the prediction unit 208 may be configured to train the travel time predictor model based on the historical data.

After training, the prediction unit 208 may be configured to utilize the travel time predictor model to predict the first travel time and the second travel time. In an embodiment, the prediction unit 208 may be configured to utilize the current location of the vehicle 104 and the real-time traffic information along the route 106 as inputs to the travel time predictor model for predicting the first travel time and the second travel time.

In an exemplary scenario, the prediction unit 208 may utilize equations (1) and (2), as shown below, to predict the first travel time and the second travel time.

zₜ=Azₜ₋₁+εₜ (1)

yₜ=Czₜ+δₜ (2)

where,

zₜ₋₁ refers to travel time to be predicted at a t−1^{th} station;

zₜ refers to travel time to be predicted at a t^{th} station;

yₜ refers to an observed travel time between the t−1^{th} and the t^{th} station;

A represents a kXk state transition matrix that relates zₜ₋₁ to zₜ. In an embodiment, the kXk state transition matrix A is determined during the training of the travel time predictor model;

C represents a pXk observation matrix that relates zₜ to yₜ. In an embodiment, the pXk observation matrix C is determined during the training of the travel time predictor model; and

εₜ and δₜ represent noise corrupting the state transition matrix A and the observation matrix C, respectively.

As shown above, the equations (1) and (2) represent the trained travel time predictor model utilized by the prediction unit 208 for predicting the travel time, such as the first travel time and the second travel time. The equations (1) and (2) further utilize the real-time traffic information to give an accurate prediction result.

For example, the trained travel time predictor model may predict that the vehicle 104 may take “1 hour” to travel from the current location to the first subsequent station and the vehicle 104 may further take “50 minutes” to travel from the first subsequent station to the second subsequent station without traffic. Based on the real-time traffic information, the trained travel time predictor model may further predict that the vehicle 104 may take “10 minutes” extra from an average travel time to travel from the current location to the first subsequent station and “15 minutes” extra from an average travel time to travel from the first subsequent station to the second subsequent station. Thus, the prediction unit 208 may predict the first travel time as “1 hour 10 minutes” for the vehicle 104 to travel between the current location and the first subsequent station, and the second travel time as “1 hour 5 minutes” for the vehicle 104 to travel between the first subsequent station and the second subsequent station.

A person having ordinary skill in the art will understand that the abovementioned example is for illustrative purpose and should not be construed to limit the scope of the disclosure. Further, the processor 202 may be configured to store the trained travel time predictor model in the database server 108 for further use.

After the prediction of the first travel time and the second travel time, the prediction unit 208 may be configured to predict the arrival time instant of the vehicle 104 at the first subsequent station. In an embodiment, the prediction unit 208 may predict the arrival time instant of the vehicle 104 at the first subsequent station based on the first travel time of the vehicle 104. For example, the prediction unit 208 may predict that the vehicle 104 may arrive at the first subsequent station from the current location after travelling for a time duration equal to the first travel time, such as “1 hour 10 minutes.” Thus, the prediction unit 208 may add the first travel time, such as “1 hour 10 minutes,” to a current time instant, such as “10:00:00 a.m.,” to predict the arrival time instant, (i.e., “11:10:00 a.m.”) of the vehicle 104 at the first subsequent station. In a scenario, when the current location of the vehicle 104 corresponds to a station prior to the first subsequent station, the observed dwell time of the vehicle 104 at the current location may also be added to the current time instant to predict the arrival time instant.

A person having ordinary skill in the art will understand that the abovementioned example is for illustrative purpose and should not be construed to limit the scope of the disclosure.

At step 308, the first passenger demand for the vehicle at the arrival time instant at the first subsequent station is predicted, based on the historical data and the current passenger demand at the first subsequent station. In an embodiment, the prediction unit 208, in conjunction with the processor 202, may be configured to predict the first passenger demand for the vehicle 104 at the arrival time instant at the first subsequent station, based on the historical data and the current passenger demand at the first subsequent station.

In an embodiment, the first passenger demand at the first subsequent station may correspond to a count of passengers that are predicted to be waiting to board the vehicle 104 at the first subsequent station, when the vehicle 104 arrives at the first subsequent station. Thus, the prediction unit 208 may be configured to predict the first passenger demand for the vehicle 104 at the arrival time instant of the vehicle 104 at the first subsequent station. For example, the prediction unit 208 may predict the arrival time instant of the vehicle 104 at the first subsequent station to be “11:10:00 a.m.” In such a case, the prediction unit 208 may predict the first passenger demand for the vehicle 104 at the first subsequent station at “11:10:00 a.m.”

In an embodiment, the prediction unit 208 may be configured to utilize the information pertaining to the observed passenger demand for the vehicle 104 at each of the plurality of stations to predict the first passenger demand. For predicting the first passenger demand, the prediction unit 208 may be configured to train a demand predictor model based on the observed passenger demand for the vehicle 104 at each of the plurality of stations. In an embodiment, the prediction unit 208 may utilize the one or more filtering techniques, such as Kalman filtering technique or Hidden Markov Model (HMM) filtering technique, known in the art for the training the demand predictor model. In an embodiment, the prediction unit 208 may be configured to train the demand predictor model, such that the transition of demand may remain same for each of the plurality of stations along the route 106 of transit.

After training, the prediction unit 208 may be configured to utilize the trained demand predictor model to predict the first passenger demand at the arrival time instant of the vehicle 104 at the first subsequent station. The prediction unit 208 may be configured to use the current passenger demand at the first subsequent station as an input for the trained demand predictor model to predict the first passenger demand at the arrival time instant of the vehicle 104 at the first subsequent station. For example, the prediction unit 208 may utilize the current passenger demand (i.e., “10 passengers”) at the first subsequent station as input for the trained demand predictor model. Thereafter, the trained demand predictor model may predict the first passenger demand (such as “15 passengers”) at the arrival time instant (i.e., “11:10:00 a.m.”) of the vehicle 104 at the first subsequent station, as the output.

A person having ordinary skill in the art will understand that the scope of the abovementioned example is for illustrative purpose and should not be construed to limit the scope of the disclosure. Further, the processor 202 may be configured to store the trained demand predictor model in the database server 108 for further use.

At step 310, the dwell time for the vehicle corresponding to the first subsequent station is predicted, based on the first passenger demand for the vehicle at the first subsequent station at the arrival time instant of the vehicle at the first subsequent station. In an embodiment, the prediction unit 208, in conjunction with the processor 202, may be configured to predict the dwell time for the vehicle 104 corresponding to the first subsequent station, based on the first passenger demand for the vehicle 104 at the first subsequent station at the arrival time instant of the vehicle 104 at the first subsequent station.

In an embodiment, the dwell time corresponding to a station may correspond to a time interval elapsed between the arrival time instant of the vehicle 104 at the station and a departure time instant of the corresponding vehicle 104 from the station. For example, the vehicle 104 may arrive at the first subsequent station at “11:10:00 a.m.” and may depart from the first subsequent station at “11:10:21 a.m.” In such a case, the dwell time corresponding to the first subsequent station may be “21 seconds.” In a scenario, when the exact departure time of the vehicle 104 for the station is unavailable, the departure time may be determined based on a pre-defined speed threshold of the vehicle 104. For example, after the arrival time instant, a time instant at which the speed of the vehicle 104 exceeds the pre-defined speed threshold (such as “3 miles/hr”), may correspond to the departure time instant.

A person having ordinary skill in the art will understand that the scope of the abovementioned examples are for illustrative purpose and should not be construed to limit the scope of the disclosure

Before predicting the dwell time, the prediction unit 208 may be configured to train a dwell time predictor model for the prediction of the dwell time. In an embodiment, the prediction unit 208 may train the dwell time predictor model based on a relationship between the observed passenger demand at each of the plurality of stations and the observed dwell time at each of the plurality of stations. Table 1, as shown below, illustrates an exemplary relationship between the observed passenger demand at each of the plurality of stations and the observed dwell time at each of the plurality of stations.

TABLE 1
Relationship between observed passenger demand at each
of the plurality of stations and observed dwell time at each
of the plurality of stations.

| Observed passenger demand range | Observed dwell time (seconds) |
|---|---|
| 0-10 | 21 |
| 11-29 | 26 |
| 30-68 | 37 |
| 69-143 | 39 |
| >143 | 69 |

After training the dwell time predictor model, the prediction unit 208 may be configured to utilize the predicted first passenger demand as an input for the dwell time predictor model to predict the dwell time (of the vehicle 104) corresponding to the first subsequent station. For example, at the first subsequent station, the predicted first passenger demand for the vehicle 104 may be “15 passengers.” In such a case, the dwell time predictor model may predict the dwell time of the vehicle 104 corresponding to the first subsequent station to be “26 seconds.”

A person having ordinary skill in the art will understand that the abovementioned example is for illustrative purpose and should not be construed to limit the scope of the disclosure.

At step 312, the arrival time instant of the vehicle at the second subsequent station is predicted, based on the predicted first travel time, the predicted second travel time, and the predicted dwell time. In an embodiment, the prediction unit 208, in conjunction with the processor 202, may be configured to predict the arrival time instant of the vehicle 104 at the second subsequent station, based on the predicted first travel time, the predicted second travel time, and the predicted dwell time.

In an exemplary scenario, the prediction unit 208 may predict that the vehicle 104 may arrive at the first subsequent station from the current location after travelling for a time duration equal to the first travel time, such as “1 hour 10 minutes.” Thereafter, the prediction unit 208 may predict the dwell time corresponding to the first subsequent station as “21 seconds.” Further, the vehicle 104 may arrive at the second subsequent station from the first subsequent station after travelling for a time duration equal to the predicted second travel time, such as “1 hour 5 minutes.” Thus, the prediction unit 208 may add the first travel time, such as “1 hour 10 minutes,” the dwell time, such as “21 seconds,” the second travel time, such as “1 hour 5 minutes, to the current time instant, such as “10:00:00 a.m.,” to predict the arrival time instant (i.e., “12:15:21 a.m.”) of the vehicle 104 at the second subsequent station.

A person having ordinary skill in the art will understand that the abovementioned exemplary scenario is for illustrative purpose and should not be construed to limit the scope of the disclosure.

At step 314, the second passenger demand for the vehicle at the predicted arrival time instant at the second subsequent station is predicted, based on the historical data and the current passenger demand at the second subsequent station. In an embodiment, the prediction unit 208, in conjunction with the processor 202, may be configured to predict the second passenger demand for the vehicle 104 at the predicted arrival time instant at the second subsequent station. In an embodiment, the prediction unit 208 may be configured to predict the second passenger demand for the vehicle 104 based on the historical data and the current passenger demand at the second subsequent station.

In an embodiment, the prediction unit 208 may utilize the trained demand predictor model to predict the second passenger demand for the vehicle 104 at the predicted arrival time instant at the second subsequent station. The prediction unit 208 may use the current passenger demand at the second subsequent station as input for the trained demand predictor model. Thereafter, the trained demand predictor model may predict the second passenger demand for the vehicle 104 at the predicted arrival time instant at the second subsequent station as output. For example, the prediction unit 208 may utilize the current passenger demand at the second subsequent station (i.e., “8 passengers”) as input for the trained demand predictor model. Thereafter, the trained demand predictor model may predict the second passenger demand (such as “13 passengers”) at the arrival time instant (i.e., “12:15:21 a.m.”) of the vehicle 104 at the second subsequent station, as the output.

At step 316, the passenger occupancy of the vehicle at the predicted arrival time instant at the second subsequent station is predicted, based on at least the first passenger demand, the second passenger demand, and the passenger alighting pattern at the first subsequent station and the second subsequent station. In an embodiment, the prediction unit 208, in conjunction with the processor 202, may be configured to predict the passenger occupancy of the vehicle 104 at the predicted arrival time instant at the second subsequent station, based on at least the first passenger demand, the second passenger demand, and the passenger alighting pattern at the first subsequent station and the second subsequent station. In an embodiment, the passenger occupancy of the vehicle 104 at any station among the plurality of stations may correspond to a count of passengers, who may want to travel in the vehicle 104 from the corresponding station to any of the subsequent stations.

Before predicting the passenger occupancy, the processor 202 may be configured to determine the passenger alighting pattern at each of the plurality of stations along the route 106 of transit. In an embodiment, the passenger alighting pattern may comprise information pertaining to a count of passengers alighting the vehicle 104 at a station of the plurality of stations, which depends on a count of passengers who boarded the vehicle 104 at one or more stations (that are prior to the station). In an embodiment, the processor 202 may be configured to determine the passenger alighting pattern based on the travel history of the plurality of passengers, the count of passengers boarding the vehicle 104 at each of the plurality of stations, and the count of passengers alighting the vehicle 104 at each of the plurality of stations, in the historical data.

For example, the passenger alighting pattern of the vehicle 104 at the second subsequent station may comprise information pertaining to a count of passengers alighting the vehicle 104 at the second subsequent station. Further, the count of passengers alighting the vehicle 104 at the second subsequent station depends on a count of passengers, who boarded the vehicle 104 at one or more stations that are prior to the second subsequent station.

For example, the processor 202 may be configured to determine the passenger alighting pattern, at each of the plurality of the stations along the route 106, in the form of a matrix or tabular data, as shown below.

| | 1^{st} station | 2^{nd} station | 3^{rd} station | . . . | N^{th} station |
|---|---|---|---|---|---|
| 1^{st} station | NA | 0.93 | 0.91 | . . . | 0.23 |
| 2^{nd} station | NA | NA | NA | . . . | 0.67 |
| 3^{rd} station | NA | NA | NA | . . . | 0.45 |
| . . . | . . . | . . . | . . . | . . . | . . . |
| N^{th} station | NA | NA | NA | . . . | NA |

In accordance with the above example, each (i, j)th cell in the matrix may represent a percentage of passengers, who alight the vehicle 104 at station “j” among those passengers who boarded the vehicle 104 at station “i.” For example, (2, 3)^{th} cell in the matrix represents that “34%” passengers, who boards the vehicle 104 from a “2^{nd} station,” alights the vehicle 104 at a “3^{rd} station.”

A person having ordinary skill in the art will understand that the abovementioned example is for illustrative purpose and should not be construed to limit the scope of the disclosure.

Thereafter, in an embodiment, the prediction unit 208 may be configured to utilize the passenger alighting pattern, the predicted first passenger demand, and the predicted second passenger demand to predict the passenger occupancy of the vehicle 104 at the predicted arrival time instant at the second subsequent station.

In an embodiment, the prediction unit 208 may be configured to predict the passenger occupancy of the vehicle 104 at the predicted arrival time instant at the second subsequent station based on the passenger occupancy of the vehicle 104 at the current location. In a scenario, the first subsequent station may correspond to a first station of the route 106, such that there is no station prior to the first subsequent station. In such a case, the passenger occupancy of the vehicle 104 at the current location may be “zero.” In another scenario, the first subsequent station may correspond to an intermediate station of the route 106. In such a case, the passenger occupancy of the vehicle 104 at the current location may not be “zero” and there may be some passengers already travelling in the vehicle 104. Such passengers may have boarded the vehicle 104 at one or more stations prior to the first subsequent station.

In an exemplary scenario, the prediction unit 208 may be configured to utilize equation (3), as shown below, to predict the passenger occupancy of the vehicle 104 at the predicted arrival time instant at the second subsequent station:

Passenger occupancy=A+Pᵢₙ−Pₒᵤₜ (3)

where,

A represents the passenger occupancy of the vehicle 104 at the current location;

Pᵢₙ represents a sum of the predicted first passenger demand and the predicted second passenger demand; and

Pₒᵤₜ represents a sum of the count of passengers alighting at the first subsequent station and the second subsequent station. In an embodiment, the prediction unit 208 may determine Pₒᵤₜ based on the determined passenger alighting pattern.

A person having ordinary skill in the art will understand that the abovementioned exemplary scenario is for illustrative purpose and should not be construed to limit the scope of the disclosure. Further, the scope of the disclosure is not limited to predicting the passenger occupancy of the vehicle 104 at the predicted arrival time instant at the second subsequent station.

In an embodiment, the prediction unit 208 may be configured to predict the passenger occupancy of the vehicle 104 at the predicted arrival time instant at the first subsequent station, based on the first passenger demand and the passenger alighting pattern at the first subsequent station. The prediction unit 208 may be configured to utilize the equation (3) to predict the passenger occupancy of the vehicle 104 at the predicted arrival time instant at the first subsequent station.

At step 318, the predicted passenger occupancy of the vehicle is rendered on the user-interfaces of the plurality of mobile computing devices associated with the vehicle service provider and/or the plurality of passengers. In an embodiment, the processor 202, in conjunction with the transceiver 206, may be configured to render the predicted passenger occupancy of the vehicle 104 on the user-interfaces of the plurality of mobile computing devices 112 associated with the vehicle service provider and/or the plurality of passengers. In an embodiment, each of the plurality of users and/or the service provider of the vehicle 104 may take one or more decisions based on the rendered passenger occupancy of the vehicle 104 on the user-interfaces of the corresponding plurality of mobile computing devices 112. In another embodiment, the processor 202 may be configured to render the predicted passenger occupancy of the vehicle 104 on the mobile computing device, such as one of the mobile computing devices 112A to 112C, associated with the service provider of the vehicle 104 or the passenger, who transmitted the request.

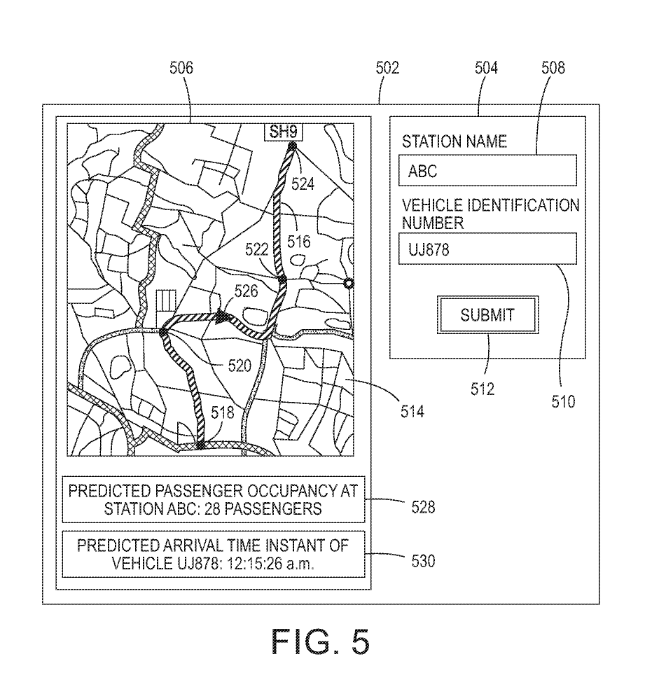

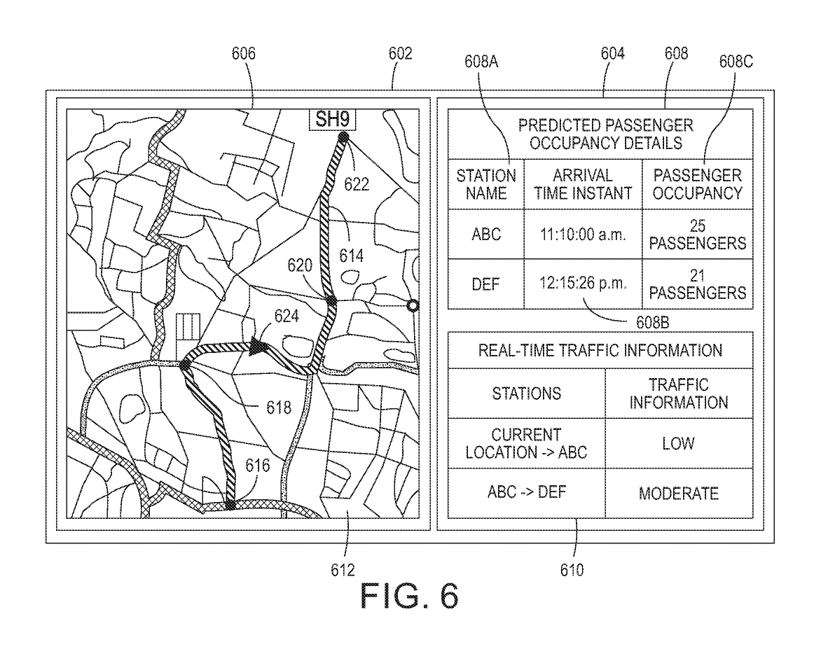

An embodiment of the user-interface to render the predicted passenger occupancy of the vehicle 104 has been described later in FIG. 5 and FIG. 6.

Control passes to end step 320.

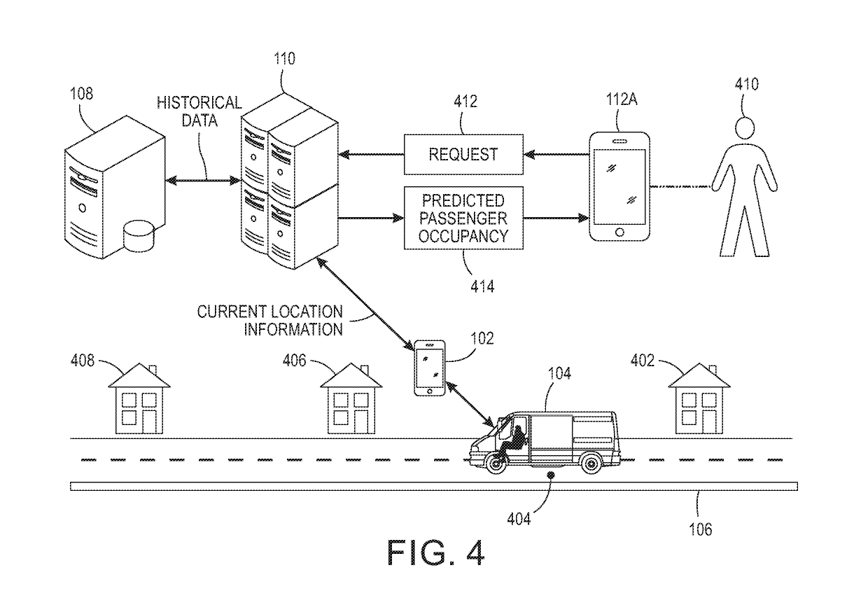

FIG. 4 is a block diagram that illustrates an exemplary scenario for real-time prediction of crowdedness in vehicles in transit, in accordance with at least one embodiment. FIG. 4 is described in conjunction with FIG. 1 to FIGS. 3A and 3B. With reference to FIG. 4, there is shown an exemplary scenario 400 that illustrates a method for real-time prediction of crowdedness in the vehicle 104 along the route 106 of transit.

The exemplary scenario 400 illustrates the vehicle 104 travelling along the route 106. The vehicle 104 has already crossed a previous station 402 on the route 106 and is at a current location 404. Further, the vehicle 104 is progressing towards a first subsequent station 406 and a second subsequent station 408 along the route 106. Further, at the current location 404, there may be “17 passengers” travelling in the vehicle 104.

A passenger 410 associated with the mobile computing device 112A may transmit a request 412 to the application server 110 to inquire about passenger occupancy of the vehicle 104, on arrival at the second subsequent station 408. After receiving the request 412, the application server 110 may query the vehicle-computing device 102 installed in the vehicle 104 to retrieve information pertaining to the current location 404 of the vehicle 104. The one or more positional sensors in the vehicle-computing device 102 may detect the current location 404 of the vehicle 104 at a current time instant “10:00:00 a.m.” Thereafter, the vehicle-computing device 102 may transit the information pertaining to the current location 404 of the vehicle 104 to the application server 110. The application server 110 may further query the database server 108 to retrieve information comprising the historical data, and the current passenger demand at the first subsequent station 406 and the second subsequent station 408. The application server 110 may further retrieve the real-time traffic information along the route 106 from one or more traffic tracking agencies (not shown).

Thereafter, the application server 110 may predict the first travel time (such as “1 hour 10 minutes”) of the vehicle 104 between the current location 404 and the first subsequent station 406, and the second travel time (such as “1 hour 5 minutes”) of the vehicle 104 between the first subsequent station 406 and the second subsequent station 408. The application server 110 may utilize the trained travel time predictor model to predict the first travel time and the second travel time of the vehicle 104. The application server 110 may utilize the current location 404 of the vehicle 104 and the real-time traffic information as input for the trained travel time predictor model for predicting the first travel time (such as “1 hour 10 minutes”) and the second travel time (such as “1 hour 5 minutes”). Thereafter, based on the predicted first travel time (such as “1 hour 10 minutes”) of the vehicle 104, the application server 110 may predict the arrival time instant (i.e., “11:10:00 a.m.”) of the vehicle 104 at the first subsequent station 406.

Further, the application server 110 may predict the first passenger demand (such as “15 passengers”) for the vehicle 104 at the arrival time instant (i.e., “11:10:00 a.m.”) at the first subsequent station 406 by utilizing the trained demand predictor model. The application server 110 may utilize the current passenger demand at the first subsequent station 406 as an input for the trained demand predictor model for predicting the first passenger demand. Thereafter, the application server 110 may utilize the predicted first passenger demand as an input for the trained dwell time predictor model to predict the dwell time (such as “26 seconds”) for the vehicle 104 corresponding to the first subsequent station 406.

Thereafter, based on the predicted first travel time, the predicted second travel time, and the predicted dwell time, the application server 110 may predict the arrival time instant (such as “12:15:26 p.m.”) of the vehicle 104 at the second subsequent station 408. Thereafter, the application server 110 may further utilize the demand predictor model to predict the second passenger demand (such as “16 passengers”) for the vehicle 104 at the predicted arrival time instant (such as “12:15:26 p.m.”) at the second subsequent station 408. The application server 110 may utilize the current passenger demand at the second subsequent station 408 as an input for the demand predictor model for predicting the second passenger demand (such as “16 passengers”). Further, the application server 110 may utilize the determined passenger alighting pattern to predict the count of passengers, such as “6 passengers” and “8 passengers,” alighting at first subsequent station 406 and the second subsequent station 408, respectively.

The application server 110 may further utilize the first passenger demand (such as “15 passengers”), the second passenger demand (such as “16 passengers”), the count of passengers alighting at first subsequent station 406 and the second subsequent station 408 (such as “6 passengers” and “8 passengers,” respectively), and the current count of passengers (such as “17 passengers”) travelling in the vehicle 104 to predict the passenger occupancy (such as “28 passengers”) of the vehicle 104 at the predicted arrival time instant (such as “12:15:26 p.m.”) at the second subsequent station 408.

After predicting the passenger occupancy of the vehicle 104 at the second subsequent station 408, the application server 110 may render the predicted passenger occupancy 414 (such as “28 passengers”) on the mobile computing device 112A associated with the passenger 410 through a user-interactive dashboard. The passenger 410 may take one or more decisions (such as a decision to board the vehicle 104 on arrival at the second subsequent station 408) based on the predicted passenger occupancy 414 of the vehicle 104 at the second subsequent station 408.

A person having ordinary skill in the art will understand that the abovementioned exemplary scenario is for illustrative purpose and should not be construed to limit the scope of the disclosure. Further, the scope of the disclosure is not limited to predicting the passenger occupancy of the vehicle 104 at the second subsequent station 408. The passenger occupancy of the vehicle 104 at the first subsequent station 406 may also be predicted, in similar manner, without deviating from the scope of the disclosure. Further, in an embodiment, the route 106 may have a third subsequent station, a fourth subsequent station, and so on. In another embodiment, the previous station 402 may correspond to the current location 404 of the vehicle 104.

FIG. 5 is a block diagram that illustrates an exemplary scenario to render a first user-interface on a mobile computing device associated with a passenger for displaying a real-time prediction of crowdedness in a vehicle at a station, in accordance with at least one embodiment. FIG. 5 is described in conjunction with FIG. 1 to FIGS. 3A and 3B.

With reference to FIG. 5, there is shown an exemplary scenario 500 to render a first user-interface 502 on a mobile computing device, such the mobile computing device 112A, associated with a passenger for displaying a real-time prediction of crowdedness in any vehicle, such as the vehicle 104, at the one or more subsequent stations, such as the first subsequent station and the second subsequent station. The first user-interface 502, such as a user-interactive dashboard, comprises a first section 504 and a second section 506. The passenger associated with the mobile computing device 112A may utilize the first section 504 to input the request by utilizing a first input box 508 and a second input box 510. In a scenario, the passenger may want to inquire about the passenger occupancy of a specific vehicle, on arrival at a specific subsequent station along a route of transit. In such a case, the passenger may input the information, such as a station name, pertaining to the specific subsequent station in the first input box 508. The passenger may input the information, such as a vehicle identification number, pertaining to the specific vehicle in the second input box 510. The first section 504 further comprises a tab 512 “SUBMIT.” The passenger may click on the tab 512 “SUBMIT” to submit the request.

When the passenger has submitted the request by clicking on the tab 512 “SUBMIT,” a navigational map 514 is presented to the passenger in the second section 506. The navigational map 514 presents a route 516 on which the specific vehicle is currently in transit. Further, one or more stations, such as stations 518 and 520, which are already crossed by the specific vehicle while travelling along the route 516 are displayed on the navigational map 514. Also, the one or more subsequent stations, such as subsequent stations 522 and 524, which are yet to be crossed by the specific vehicle are displayed on the navigational map 514. Further, a current location 526 of the specific vehicle is also displayed on the navigational map 514. The predicted passenger occupancy of the specific vehicle at the specific subsequent station is also displayed to the passenger as a first graphical and/or textual indication 528 in the second section 506. The current location 526 of the specific vehicle is updated as the vehicle progresses along the route 516. In an embodiment, the second section 506 may further present the predicted arrival time instant of the required vehicle at the required subsequent station as a second graphical and/or textual indication 530.

A person having ordinary skill in the art will understand that the abovementioned exemplary scenario is for illustrative purpose and should not be construed to limit the scope of the disclosure.

FIG. 6 is a block diagram that illustrates an exemplary scenario to render a second user-interface on a mobile computing device associated with a service provider of a vehicle for displaying a real-time prediction of crowdedness in the vehicle at a plurality of stations along a route of transit, in accordance with at least one embodiment. FIG. 6 is described in conjunction with FIG. 1 to FIGS. 3A and 3B.

With reference to FIG. 6, there is shown an exemplary scenario 600 to render a second user-interface 602 on a mobile computing device, such as the mobile computing device 112B, associated with the service provider of a vehicle, such as the vehicle 104, for displaying a real-time prediction of crowdedness in the vehicle 104 at one or more subsequent stations along a specific route of transit. The second user-interface 602 comprises a first section 604 and a second section 606. The first section 604 presents the real-time prediction of the passenger occupancy of the vehicle 104, at the one or more subsequent stations along the specific route of transit, as a first tabular format 608 “PREDICTED PASSENGER OCCUPANCY DETAILS.” The first tabular format 608 may comprise a first column 608A, where the information, such as station names “ABC” and “DEF,” pertaining to the one or more subsequent stations is presented. The first tabular format 608 may further comprise a second column 608B, where the predicted arrival time instant of the vehicle 104 at the one or more subsequent stations is presented. Further, the first tabular format 608 may comprise a third column 608C, where the predicted passenger occupancy of the vehicle 104 at the arrival time instant at each of the one or more subsequent stations is presented. The first section 604 further presents real-time traffic information as a second tabular format 610 to the service provider of the vehicle 104.

The second section 606 presents a navigational map 612 to the service provider. The navigational map 612 presents a route 614 on which the vehicle 104 is currently in transit. Further, one or more stations, such as stations 616 and 618, which are already crossed by the vehicle 104 while travelling along the route 614 are displayed on the navigational map 612. Further, the one or more subsequent stations, such as subsequent stations 620 and 622, which are yet to be crossed by the vehicle 104 are also displayed on the navigational map 612. Further, a current location indicator 624 of the vehicle is also displayed on the navigational map 612. The current location indicator 624 of the vehicle 104 is updated as the vehicle 104 progresses along the route 614.

A person having ordinary skill in the art will understand that the abovementioned exemplary scenario is for illustrative purpose and should not be construed to limit the scope of the disclosure.

The disclosed embodiments encompass numerous advantages. The disclosure provides a method and a system of data processing for real-time prediction of crowdedness in vehicles in transit. The disclosed method utilizes different sources of data, such as ticket validation systems, real-time traffic tracking agencies, and an origin-destination estimate matrix, during operation of a transit network to predict the crowdedness in the vehicles before they reach at one or more subsequent stations. The real-time predictions, such as the predicted crowdedness and predicted arrival time instant of the vehicle at the one or more subsequent stations may be transmitted to a service provider of the vehicle and/or a plurality of passengers, which enables them to take one or more informed decisions. The disclosed method utilizes real-time data, such as current passenger demand, real-time traffic information, and current location of the vehicle, for prediction. Thus, it automatically adapts to any dynamic variation in the real-time data. Various predictions of the disclosed method changes, when the real-time data changes. The disclosed method and system can be utilized any service provider dealing with transportation services to control the scheduling of the vehicles along the route of transit. The disclosed method and system can be utilized by a plurality of passengers who may want to avail various transport services for commuting.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or other similar devices that enable the computer system to connect to databases and networks, such as, LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or only hardware, or using a varying combination of the two techniques. The disclosure is independent of the programming language and the operating system used in the computers. The instructions for the disclosure can be written in all programming languages, including, but not limited to, ‘C’, ‘C++’, ‘Visual C++’ and ‘Visual Basic’. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, ‘Unix’, ‘DOS’, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems of data processing for real-time prediction of crowdedness in vehicles in transit have been disclosed. However, it should be apparent to those skilled in the art that modifications in addition to those described are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method of data processing by a computing device for real-time prediction of crowdedness in vehicles in transit, the method comprising:
receiving, by one or more transceivers in the computing device, a current location of a vehicle from one or more positional sensors installed in the vehicle, a real-time traffic information along a route of transit, and a current passenger demand for the vehicle at a first subsequent station and a second subsequent station along the route of transit;
predicting, by one or more processors in the computing device, a dwell time for the vehicle corresponding to the first subsequent station based on a first passenger demand for the vehicle at the first subsequent station at an arrival time instant of the vehicle at the first subsequent station;
predicting, by the one or more processors, an arrival time instant of the vehicle at the second subsequent station based on a predicted first travel time of the vehicle between the current location and the first subsequent station, a predicted second travel time of the vehicle between the first subsequent station and the second subsequent station, and the predicted dwell time;
predicting, by the one or more processors, a passenger occupancy of the vehicle at the predicted arrival time instant at the second subsequent station based on at least the first passenger demand, a second passenger demand associated with the second subsequent station, and a passenger alighting pattern at the first subsequent station and the second subsequent station; and
rendering, by the one or more processors, the predicted passenger occupancy of the vehicle at user-interfaces of a plurality of mobile computing devices associated with a vehicle service provider and/or a plurality of passengers.

2. The method of claim 1, further comprising predicting, by the one or more processors, the first travel time and the second travel time, based on historical data, the received current location, and the received real-time traffic information.

3. The method of claim 1, wherein the arrival time instant of the vehicle at the first subsequent station is predicted based on the predicted first travel time of the vehicle.

4. The method of claim 1, further comprising predicting, by the one or more processors, the first passenger demand for the vehicle at the predicted arrival time instant at the first subsequent station based on historical data and the received current passenger demand at the first subsequent station.

5. The method of claim 1, further comprising predicting, by the one or more processors, the second passenger demand for the vehicle at the predicted arrival time instant at the second subsequent station based on historical data and the received current passenger demand at the second subsequent station.

6. The method of claim 1, further comprising predicting, by the one or more processors, the passenger occupancy of the vehicle at the predicted arrival time instant at the first subsequent station, based on the first passenger demand and the passenger alighting pattern at the first subsequent station.

7. The method of claim 1, where in the prediction of the passenger occupancy at the first subsequent station and/or the second subsequent station is further based on a passenger occupancy of the vehicle at the current location.

8. The method of claim 1, wherein historical data comprises at least an observed travel time of the vehicle among a plurality of stations along the route of transit, a count of passengers boarding the vehicle at each of the plurality of stations, a count of passengers alighting the vehicle at each of the plurality of stations, and an observed passenger demand for the vehicle at each of the plurality of stations, wherein the plurality of stations comprises at least the first subsequent station and the second subsequent station.

9. The method of claim 8, wherein the passenger alighting pattern comprises information pertaining to a count of passengers alighting the vehicle at a station of the plurality of stations which depends on a count of passengers, who boarded the vehicle at one or more stations that are prior to the station.

10. The method of claim 1, wherein the current location of the vehicle is prior to the first subsequent station and the second subsequent station along the route of transit, wherein the first subsequent station is prior to the second subsequent station along the route of transit.

11. A system for data processing by a computing device for real-time prediction of crowdedness in vehicles in transit, the system comprising:
one or more processors in the computing device configured to:
receive a current location of a vehicle from one or more positional sensors installed in the vehicle, a real-time traffic information along a route of transit, and a current passenger demand for the vehicle at a first subsequent station and a second subsequent station along the route of transit;
predict a dwell time for the vehicle corresponding to the first subsequent station based on a first passenger demand for the vehicle at the first subsequent station at an arrival time instant of the vehicle at the first subsequent station;
predict an arrival time instant of the vehicle at the second subsequent station based on a predicted first travel time of the vehicle between the current location and the first subsequent station, a predicted second travel time of the vehicle between the first subsequent station and the second subsequent station, and the predicted dwell time; and
predict a passenger occupancy of the vehicle at the predicted arrival time instant at the second subsequent station based on at least the first passenger demand, a second passenger demand associated with the second subsequent station, and a passenger alighting pattern at the first subsequent station and the second subsequent station, wherein the predicted passenger occupancy of the vehicle is rendered at user-interfaces of a plurality of mobile computing devices associated with a vehicle service provider and/or a plurality of passengers.

12. The system of claim 11, wherein the one or more processors are further configured to predict the first travel time and the second travel time, based on historical data, the received current location, and the received real-time traffic information.

13. The system of claim 11, wherein the arrival time instant of the vehicle at the first subsequent station is predicted based on the predicted first travel time of the vehicle.

14. The system of claim 11, wherein the one or more processors are further configured to predict the first passenger demand for the vehicle at the predicted arrival time instant at the first subsequent station based on historical data and the received current passenger demand at the first subsequent station.

15. The system of claim 11, wherein the one or more processors are further configured to predict the second passenger demand for the vehicle at the predicted arrival time instant at the second subsequent station based on historical data and the received current passenger demand at the second subsequent station.

16. The system of claim 11, wherein the one or more processors are further configured to predict the passenger occupancy of the vehicle at the predicted arrival time instant at the first subsequent station, based on the first passenger demand and the passenger alighting pattern at the first subsequent station.

17. The system of claim 11, where in the prediction of the passenger occupancy at the first subsequent station and/or the second subsequent station is further based on a passenger occupancy of the vehicle at the current location.

18. The system of claim 11, wherein historical data comprises at least an observed travel time of the vehicle among a plurality of stations along the route of transit, a count of passengers boarding the vehicle at each of the plurality of stations, a count of passengers alighting the vehicle at each of the plurality of stations, and an observed passenger demand for the vehicle at each of the plurality of stations, wherein the plurality of stations comprises at least the first subsequent station and the second subsequent station.

19. The system of claim 18, wherein the passenger alighting pattern comprises information pertaining to a count of passengers alighting the vehicle at a station of the plurality of stations which depends on a count of passengers, who boarded the vehicle at one or more stations that are prior to the station.

20. A computer program product for use with a computer, the computer program product comprising a non-transitory computer readable medium, wherein the non-transitory computer readable medium stores a computer program code of data processing for real-time prediction of crowdedness in vehicles in transit, wherein the computer program code is executable by one or more processors in a computing device to:
receive a current location of a vehicle from one or more positional sensors installed in the vehicle, a real-time traffic information along a route of transit, and a current passenger demand for the vehicle at a first subsequent station and a second subsequent station along the route of transit;
predict a dwell time for the vehicle corresponding to the first subsequent station based on a first passenger demand for the vehicle at the first subsequent station at an arrival time instant of the vehicle at the first subsequent station;
predict an arrival time instant of the vehicle at the second subsequent station based on a predicted first travel time of the vehicle between the current location and the first subsequent station, a predicted second travel time of the vehicle between the first subsequent station and the second subsequent station, and the predicted dwell time; and
predict a passenger occupancy of the vehicle at the predicted arrival time instant at the second subsequent station based on at least the first passenger demand, a second passenger demand associated with the second subsequent station, and a passenger alighting pattern at the first subsequent station and the second subsequent station, wherein the predicted passenger occupancy of the vehicle is rendered at user-interfaces of a plurality of mobile computing devices associated with a vehicle service provider and/or a plurality of passengers.
